(19) United States
(12) Patent Application Publication
(10) Pub. No.: US 2014/0237085 A1
(43) Pub. Date: Aug. 21, 2014

(54) COMMUNICATION METHOD OF CONTENT REQUESTER AND CONTENT PROVIDER TO PROVIDE CONTENT AND REAL-TIME STREAMING CONTENT IN CONTENT-CENTRIC NETWORK (CCN) BASED ON CONTENT NAME

(71) Applicant: Samsung Electronics Co., Ltd., Suwon-si (KR)

(72) Inventors: Joong Hong PARK, Yongin-si (KR); Jae Hoon KIM, Yongin-si (KR); Myeong Wuk JANG, Yongin-si (KR)

(73) Assignee: Samsung Electronics Co., Ltd., Suwon-si (KR)

(21) Appl. No.: 14/263,275

(22) Filed: Apr. 28, 2014

Related U.S. Application Data
(63) Continuation of application No. PCT/KR2013/006272, filed on Jul. 12, 2013.

(30) Foreign Application Priority Data
Jul. 13, 2012 (KR) 10-2012-0076535
Jul. 12, 2013 (KR) 10-2013-0082125

(51) Int. Cl. H04L 29/06

(52) U.S. Cl. CPC H04L 65/60
USPC 709/219

(57) ABSTRACT

Provided is a communication method of a content requester to provide content in a Content-Centric Network (CCN). The method is based on a content name, including generating a content request packet including an identifier indicating a content request based on a predetermined time unit to request content, transmitting the generated content request packet, and receiving segments of the content that correspond to the predetermined time unit. Also provided are corresponding communication methods of a content provider and a node in the CCN.

### CROSS-REFERENCE TO RELATED APPLICATIONS

This application claims the benefit under 35 U.S.C. 119(a) of Korean Application No. 10-2012-0076535 filed on Jul. 13, 2012 and Korean Application No. 10-2013-0082125 filed on Jul. 12, 2013, the entire disclosures of which are incorporated herein by reference for all purposes.

This application additionally claims the benefit under 35 U.S.C. 119(a) and 365(a) of International Application No. PCT/KR2013/006272 filed on Jul. 12, 2013, the entire disclosure of which is incorporated herein by reference for all purposes.

### BACKGROUND

1. Field

The following description relates to a communication method of a content requester and a content provider to provide content and real-time streaming content using a predetermined time unit in a Content-Centric Network (CCN) based on a content name.

2. Description of Related Art

In Content-Centric Networks (CCNs), packets are classified into content request packets and content response packets. A content request packet contains a name of content to be requested, and a content response packet contains requested content, a name of the requested content, and other information about the content. Such a content request packet may be referred to as an “interest.”

For example, when a content request packet is received, network equipment may search for content using a storage resources of the network equipment based on a name of the content included in a header of the content request packet. In this example, when the requested content is found, the network equipment may transfer the content to a content requesting device. In this manner, the content request is satisfied by a content response packet that handles the needs of the content requesting device. Thus, a CCN may reply to a content request packet when corresponding content is stored and available in a storage area of an intermediate node of the CCN, regardless of what type of intermediate nodes has available the requested content. By comparison, a network based on an Internet Protocol (IP) only receives content directly from the original owner of the content.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a communication method of a content requester to provide content in a Content-Centric Network (CCN) based on a content name includes generating a content request packet, including an identifier indicating a content request based on a predetermined time unit, to request the content, transmitting the content request packet; and receiving segments of the content that correspond to the predetermined time unit.

The content may include either real-time streaming content or general content.

The generating may include generating a content request packet requesting the segments of the content using a name of the content.

The generating may include adding the identifier to a header of the content request packet or to a name of the content.

The generating may include adding, to a header of the content request packet, information regarding a starting segment of the content and the predetermined time unit to which the content corresponds.

The communication method may further include transmitting a content request packet including information regarding a segment sequentially following a segment received last by a content request packet corresponding to the predetermined time unit and a time unit sequentially following the predetermined time unit, in response to the predetermined time unit expiring.

The communication method may further include adjusting the predetermined time unit, based on a characteristic of at least one of the content requester and a network environment.

The communication method may further include storing the predetermined time unit corresponding to the content request packet in a Pending Interest Table (PIT).

The communication method may further include deleting an entry corresponding to the content from a Pending Interest Table (PIT), in response to a cancellation response packet that includes a request for the content to be cancelled.

The deleting may include deleting the entry corresponding to the content from the PIT, using a timeout value included in the header of the content request packet.

The communication method may further include determining whether a missing segment or an out-of-order segment is included in the received segments, and waiting for a predetermined time interval, in response to the missing segment or the out-of-order segment being detected.

The communication method may further include determining whether the missing segment or the out-of-order segment is transmitted to the content requester during the predetermined time interval, generating a content request packet requesting the missing segment or the out-of-order segment, in response to determining that the missing segment or the out-of-order segment is not transmitted during the predetermined time interval, and transmitting the content request packet requesting the missing segment or the out-of-order segment, in response to the content request packet being generated.

The content request packet requesting the missing segment or the out-of-order segment may have a name field including a segment number of the missing segment or the out-of-order segment, instead of including an identifier indicating a content request based on the predetermined time unit.

The generating of the content request packet requesting the missing segment or the out-of-order segment may include comparing a number of segments that are missing or out of order with a predetermined number, and generating content request packets that have different forms and that request the missing segment or the out-of-order segment, based on a result of the comparing between the number of segments that are missing or out of order and the predetermined number.

The generating of the content request packets may include, in response to the number of the segments that are missing or out of order being equal to or less than the predetermined number, generating a content request packet including a segment number of the missing segment or the out-of-order segment.

The generating of the content request packets may include, in response to the number of the segments that are missing or out of order being greater than the predetermined number, generating a content request packet that requests the missing segment or the out-of-order segment and that includes an identifier indicating a content request based on the predetermined time unit.

The communication method may further include allocating a storage space for real-time streaming content in a content store, in response to the content being the real-time streaming content.

The communication method may further include storing a latest segment among received segments of the real-time streaming content in the storage space.

The communication method may further include requesting retransmission of the real-time streaming content using the latest segment, in response to a missing segment or an out-of-order segment being included in the segments of the real-time streaming content.

In another general aspect, a communication method of a content provider to provide content in a Content-Centric Network (CCN) based on a content name includes receiving a content request packet including an identifier indicating a content request based on a predetermined time unit, determining whether the content is included in a content store or a buffer of the content provider, generating a content response packet including segments of the content, in response to determining that the content is included in the content store or the buffer of the content provider, the segments corresponding to the predetermined time unit; and transmitting the content response packet.

The content may include either real-time streaming content or general content.

The determining may include determining whether the content is included in the content store or the buffer, using a name of the content.

The communication method may further include generating a cancellation response packet that causes a request for the content to be cancelled, in response to the content ending.

The generating of the cancellation response packet may include generating the cancellation response packet, by describing preset information for a segment number of a last segment of the content, or by setting a payload size of the last segment to a preset value.

The communication method may further include transmitting the cancellation response packet.

The receiving may include receiving a content request packet include information regarding a starting segment of the content and the predetermined time unit in which the content continues to be transmitted.

The receiving may include, in response to the predetermined time unit expiring, receiving a content request packet including information regarding a segment sequentially following a segment received last by a content request packet corresponding to the predetermined time unit and a time unit sequentially following the predetermined time unit.

The receiving includes receiving a content request packet including a segment number of a first segment among segments of the content that are not stored in a content store of an intermediate node, and a time unit obtained by subtracting a time interval required to process a segment stored in the content store of the intermediate node from the predetermined time unit.

The communication method may further include receiving a content request packet requesting a missing segment or an out-of-order segment among segments of the content.

The content request packet requesting the missing segment or the out-of-order segment may have a name field including a segment number of the missing segment or the out-of-order segment, instead of including an identifier indicating a content request based on the predetermined time unit.

In another general aspect, a communication method of a content provider to provide content in a Content-Centric Network (CCN) based on a content name includes receiving a content request packet, determining whether the content request packet is based on a predetermined time unit, deciding whether the content is real-time streaming content based on the predetermined time unit or general content based on the predetermined time unit is requested by the content request packet, based on a result of the determining, generating a content response packet in response to the deciding, and transmitting the content response packet.

The determining may include determining whether the content request packet is based on the predetermined time unit, based on determining whether an identifier indicating a content request based on the predetermined time unit is included in a header of the content request packet or a name of the content.

The deciding may include deciding, using information included in the header of the content request packet, whether the content is real-time streaming content based on the predetermined time unit or general content based on the predetermined time unit that is requested by the content request packet

The generating may include generating a content response packet including segments of the real-time streaming content, in response to the real-time streaming content based on the predetermined time unit being decided to be requested.

The generating may include generating a content response packet including the general content based on the predetermined time unit, in response to the general content based on the predetermined time unit being decided to be requested.

The communication method may further include generating a cancellation response packet that causes a request for the content to be cancelled, in response to the content ending.

The generating of the cancellation response packet may include generating the cancellation response packet, by describing preset information in a segment number of a last segment of the content, or by setting a payload size of a last segment to a preset value.

The receiving may include receiving a content request packet including information regarding a predetermined time unit to which the content corresponds.

The communication method may further include receiving a content request packet requesting a missing segment or an out-of-order segment among segments of the content, wherein the content request packet requesting the missing segment or the out-of-order segment has a name field including a segment number of the missing segment or the out-of-order segment, instead of including an identifier indicating a content request based on the predetermined time unit.

The communication method may further include generating a content response packet including general content that is not based on the predetermined time unit, in response to the content request packet being determined not to be based on the predetermined time unit.

In other general aspects, a non-transitory computer readable storage medium stores a program, the program including instructions for causing a computer to implement each of the three communication methods presented above.

In another general aspect, a communication method of a node in a Content-Centric Network (CCN) includes receiving a content request packet from a content requester, including an identifier indicating a request based on a predetermined time unit, to request the content, by a face, determining whether the requested content is present in a content store of the node, in response to the requested content being present in a content store of the node, transmitting the requested content from the content store to the content requester; in response to the requested content not being present in a content store of the node, recording a routing entry for the requested content in a Pending Interest Table (PIT) of the node, and forwarding the content request packet to another node of the CCN using a selected face to retrieve the content.

Each routing entry in the PIT may include a prefix, a face value, and a segment identifier.

The requested content may include either real-time streaming content or general content.

The forwarding may include using a Forwarding Information Base (FIB) to determine the selected face.

The communication method may further include receiving the retrieved content in response to the forwarded content request packet, and routing the content to the content requester in response to receiving the retrieved content.

In other general aspects, a non-transitory computer readable storage medium stores a program, the program including instructions for causing a computer to implement each of the additional communication method just presented, above.

Other features and aspects will be apparent from the following detailed description, the drawings, and the claims.

### BRIEF DESCRIPTION OF THE DRAWINGS

FIG. 1 is a diagram illustrating an example of an operation of processing a content request packet in a Content-Centric Network (CCN) based on a content name.

FIG. 2 is a diagram illustrating an example of an operation of a content requester and a content provider using a time-based interest protocol, to provide content in a CCN based on a content name.

FIG. 3 is a flowchart illustrating an example of a communication method of a content requester to provide content based on a predetermined time unit in a CCN based on a content name.

FIG. 4 is a flowchart illustrating an example of a communication method of a content provider to provide content based on a predetermined time unit in a CCN based on a content name.

FIG. 5 is a flowchart illustrating another example of a communication method of a content requester to provide content based on a predetermined time unit in a CCN based on a content name.

FIG. 6 is a flowchart illustrating an example of a communication method of a content requester to provide real-time streaming content based on a predetermined time unit in a CCN based on a content name.

FIG. 7 is a flowchart illustrating another example of a communication method of a content provider to provide content based on a predetermined time unit in a CCN based on a content name.

FIG. 8 is a flowchart illustrating an example of a communication method of a content provider to provide real-time streaming content based on a predetermined time unit in a CCN based on a content name.

FIG. 9 is a diagram illustrating an example of a method of ending a request for content in a CCN based on a content name.

FIG. 10 is a diagram illustrating an example of a change in a Pending Interest Table (PIT) of each of nodes between a content requester and a content provider using a time-based interest protocol, to provide content in a CCN based on a content name.

FIG. 11 is a diagram illustrating an example in which real-time streaming content is provided to a new content requester during providing of real-time streaming content based on the communication methods of FIGS. 6 and 8.

FIG. 12 is a flowchart illustrating an example of a communication method of a content provider when content based on a predetermined time unit, together with general content that is not based on a predetermined time unit, are transmitted in a CCN based on a content name.

FIG. 13 is a diagram illustrating an example of a method of restoring a hole generated during transmission of segments between a content requester and a content provider using a time-based interest protocol in a CCN.

FIG. 14 is a diagram illustrating an example of a method of processing a content store of a network node using a time-based interest protocol in a CCN.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

In the following detailed description, a “content requester” refers to a communication device or a node that requests content in a Content-Centric Network (CCN). Such content may be real-time streaming content. Correspondingly, a “content provider” refers to a communication device or a node that provides content that is requested by the content requester. Again, the content may be real-time streaming content. The content provider refers to an initial provider of corresponding content or an intermediate node including at least one portion of the corresponding content among intermediate nodes located in a route through which a content request packet is transferred. That is, the content provider is a node in the CCN that is able to provide at least part of the content that is requested.

Additionally, in the following description, an example of a content request scheme and a corresponding content response scheme using a content request packet include an identifier indicating a content request based on a predetermined time unit. Such a scheme is referred to as a “time-based interest protocol.” In an example, the “predetermined time unit” refers to a predetermined time interval, or time duration. For example, such a “predetermined time unit” may refer to a number of seconds, or a certain fraction of a second.

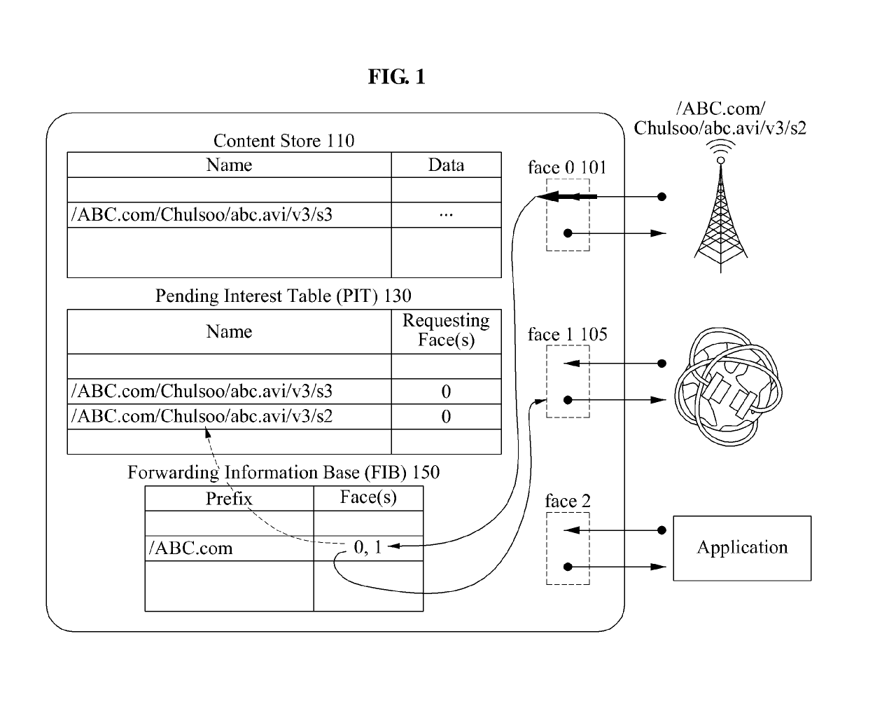

FIG. 1 illustrates an example of an operation of processing a content request packet in a CCN based on a content name.

In the CCN, a name of content may function as a directional tool to use to search for a node in which the content is stored. That is, a name of content specifies a pathway to use to navigate the CCN in a manner that specifies where to find the content. The name of the content also distinguishes the content from a different content, in terms of what information is actually included in the content. Accordingly, each specific content uses its own unique name, so that there is no confusion between differing contents. In an example in which names of two contents are different from each other, the two contents may be determined to be different contents, even if the same information is included in each of the two contents. For example, when two files contain the same information, but have different names, namely “/ABC.com/sait/video/intro.avi,” and “/ABC.com/sait/comm/video/intro.avi,” the two files may be processed as being different contents. Therefore, if two contents are retrieved by traversing the CCN using different paths, if the two contents include different information, or both, they are referred to using different names and are considered to be different contents. The above configuration may be very useful in distinguishing different contents with similar names.

FIG. 1 illustrates an operation of processing a content request packet based on a hierarchical name of content in a CCN, that is, a name-based network.

For example, referring to FIG. 1, a node included in the CCN receives, from face 0 101, a content request packet that requests content corresponding to a hierarchical name of the content. In the example of FIG. 1, such a content request packet is “/ABC.com/Chulsoo/abc.avi/v3/s2.”

In this example, based on the provided content request packet, “/ABC.com/Chulsoo/abc.avi/v3/s2,” a network module of the node determines whether the requested content is included and available in a content store 110 of the node. In accordance with thus illustrative example, the term “content store” is used interchangeably with a “content cache.” A content store 110 that is included in the node is a memory area used by the node to temporarily store information for the node. By storing information in the content store 110, frequently used information is maintained in intermediate nodes to make it available for subsequent retrieval without requiring that the information be sent from the original source of the information, thus reducing the amount of network traffic necessary in the CCN.

In response to the content being determined to be stored in the content store 110, the node returns the content to face 0 101 via which the content request packet is received. In accordance with an illustrative example, the term “face” may be used interchangeably with an “interface.” The terms “face” and “interface” refer to features that serve as conduits for information interchange between interacting components of an example. That is, if two parts of an example are to interact, a “face” or “interface” allow them to exchange information with one another.

In response to the content being determined not to be stored in the content store 110, a next step to be taken by the node, in an example, is to determine whether the content is present in a Pending Interest Table (PIT) 130. In the example of FIG. 1, the node determines whether an entry stored with “/ABC.com/Chulsoo/abc.avi/v3/s2” is included in a Pending Interest Table (PIT) 130.

In response to the entry being determined to be included in the PIT 130, in this example the node adds information associated with face 0 101 to the entry in the PIT 130. Thus, the PIT 130 is able to store information to help manage which information a node stores in its content store 110 so that the content store 110 stores the information that is the most in demand. By storing the information that is the most in demand, the content store 110 includes information that optimizes performance for the CCN.

In response to the entry being determined not to be included in the PIT 130, a next step taken by the node is to search for the entry by performing a lookup based on the content name in a Forwarding Information Base (FIB) 150. In this example, the node searches for the entry based on longest-prefix-matching. However, other search techniques are used in other examples to provide information from the FIB 150 to help facilitate routing information through the CCN.

For example, the node selects face 1 105, to which the content request packet is to be transferred, based on information registered in the FIB 150, and transmits the content request packet to the selected face 1 105.

In this example, the node registers, in the PIT 130, information “0” regarding face 0 101. The registered information is subsequently used to route a content response packet that includes content. In this example, the content included in the routed content packet corresponds to the content request packet sent by a node requesting the content, when the content response packet is transferred. Additionally, one of faces other than face 0 101 may be selected as a face, to which the content request packet is to be transferred, based on the FIB 150. Thus, the PIT 130 and the FIB 150 work together to provide various ways of routing content in situations where a content request packet requests content that is not immediately available in a content store 110 of a node.

In an example, a timeout value is included in a header of the content request packet. Accordingly the PIT 130 maintains the content request packet for a predetermined period of time. In one example, the predetermined period of time for which the PIT 130 maintains the content request packet is the timeout value, but other predetermined periods of time are used in other examples. The timeout value may be used in a method and system for providing content and real-time streaming content based on a predetermined time unit that is described further hereinafter.

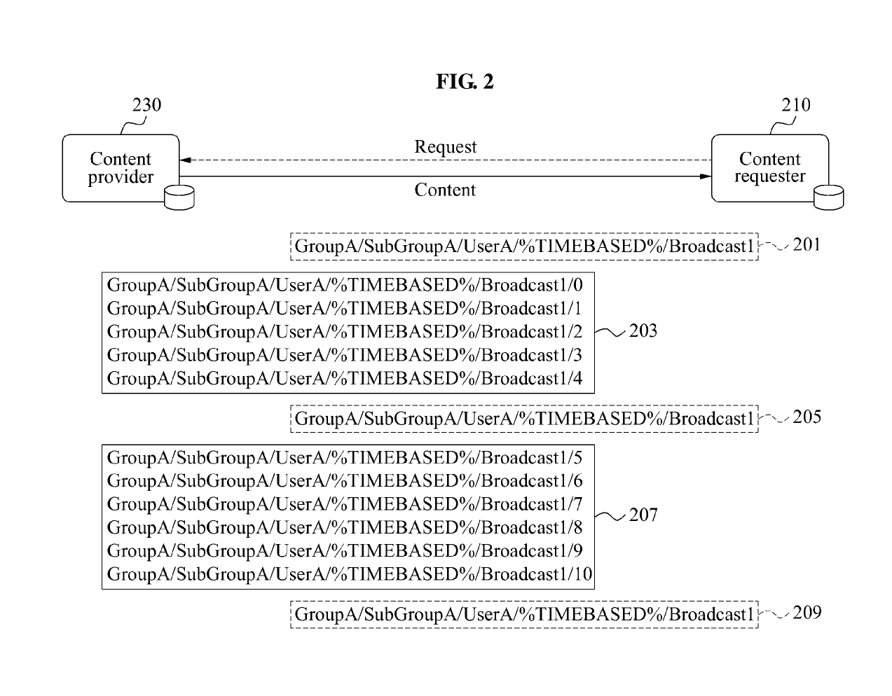

FIG. 2 illustrates an example of an operation of a content requester and a content provider using a time-based interest protocol, to provide content in a CCN based on a content name.

In the example of FIG. 2, content is requested in a predetermined time unit, instead of a segment unit. Accordingly, using a single content request packet, a plurality of segments are received. That is, a single content request packet receives a plurality of segment units, all of which are recited during a predetermined time unit.

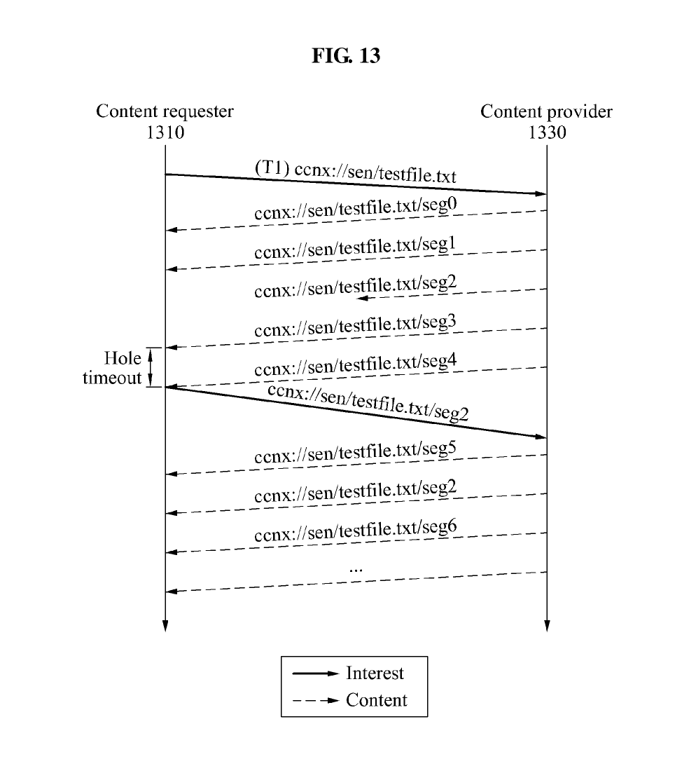

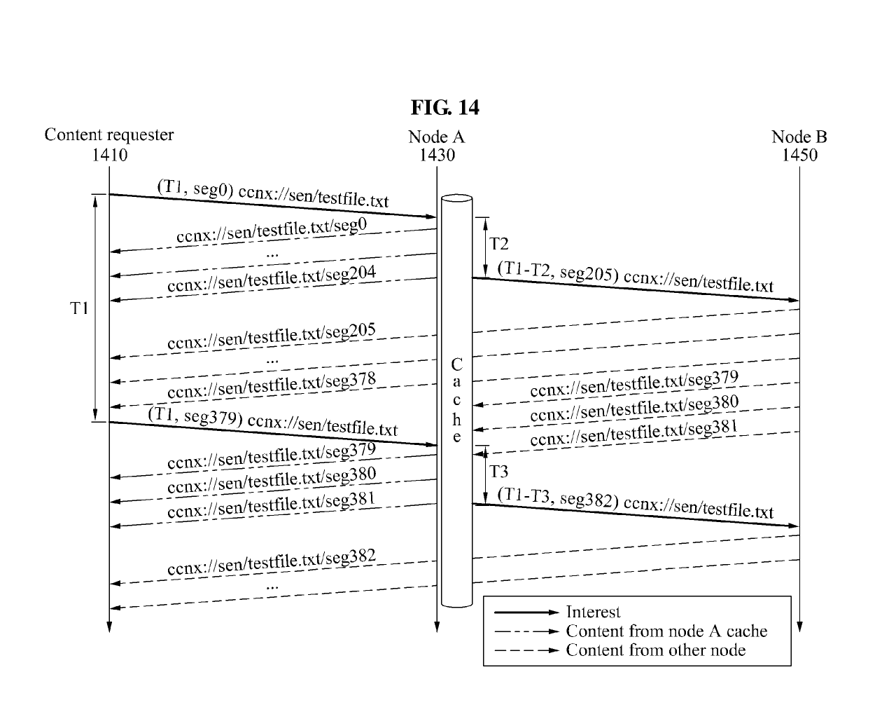

For example, to request content in a predetermined time unit, a content requester 210 adds an identifier indicating a content request based on a predetermined time unit to a name of a content request packet. Alternatively, the content requester 210 displays a special identifier on a header of the content request packet. The identifier may be represented by a specific tag, for example, “%TIMEBASED%,” or other special symbols or numerals that are set in advance. An example of requesting content in a predetermined time unit by displaying a special identifier on a header of a content request packet is further described with reference to FIGS. 13 and 14.

For example, when the identifier is “%TIMEBASED%,” an example content request packet 201 has the name:

“GroupA/SubGroupA/UserA/%TIMEBASED%/Broadcast1.”

When a content request packet including an identifier “%TIMEBASED%” is received, a content provider 230 or intermediate nodes determine, based on a name or an alternative identifier of the content request packet, that the content request packet requests content based on using a predetermined time unit. Accordingly, the content provider 230 generates a content response packet including segments of content, and transmits the generated content response packet. In this example, the segments of the content are segments that correspond to a predetermined time unit included in the content request packet.

Additionally, in an example, when the content request packet including the identifier “%TIMEBASED%” is received, the content provider 230 or intermediate nodes manages a PIT. The received content request packet requests content in a predetermined time unit, and by using a PIT, it forwards content to another node or the content requester 210.

In addition, a name of the content response packet transmitted by the content provider 230 includes, for example, information related to a segment, such as “GroupA/SubGroupA/UserA/%TIMEBASED%/Broadcast1/SegmentNum,” information regarding a predetermined time unit, such as “GroupA/SubGroupA/UserA/%TIMEBASED%/Broadcast1/TimeInfo,” or both the information of the segment and the information regarding the predetermined time unit, such as “GroupA/SubGroupA/UserA/%TIMEBASED%/Broadcast1/SegmentNum/TimeInfo.”

By incorporating a segment number (SegmentNum) and information regarding the predetermined time unit (TimeInfo) into the content response packet, it becomes possible to manage transmitting segments in coordination with time intervals regulated with respect to the predetermined time unit.

FIG. 2 illustrates a structure in which the content requester 210 requests content in a predetermined time unit and the content provider 230 transfers segments of the content.

In the example of FIG. 2, the content requester 210 transmits a single content request packet including content names of content based on a predetermined time unit. For example, FIG. 2 shows content names 201, 205 and 209. In FIG. 2, it also shows receiving content response packets that include a plurality of segments, for example segments 203 and 207.

According to examples, content may be requested in a predetermined time unit, and all content segments corresponding to the predetermined time unit are be transferred, regardless of a number of the content segments. In examples, the content requester 210 adaptively transmits a content request packet, by adjusting the predetermined time unit based on at least one characteristic of the content requester 210 or a network environment.

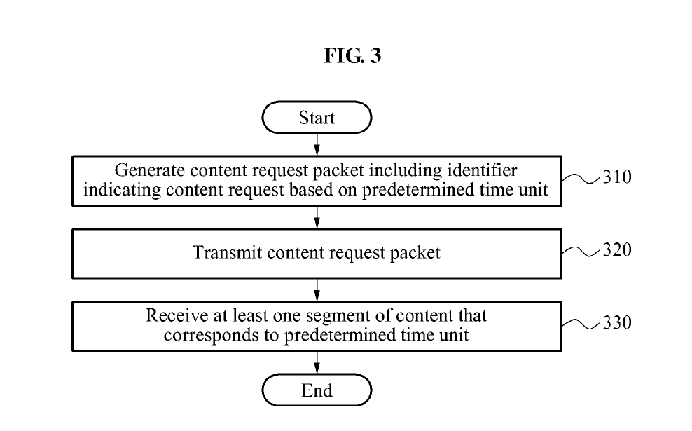

Hereinafter, various examples of a method of providing content between a content requester and a content provider based on a predetermined time unit will be described with reference to FIGS. 3 through 8.

FIG. 3 illustrates an example of a communication method of a content requester to provide content based on a predetermined time unit in a CCN based on a content name.

Referring to FIG. 3, in 310, the method generates a content request packet including an identifier indicating a content request based on a predetermined time unit. For example, the content requester 210 generates a content request packet including an identifier indicating a content request based on a predetermined time unit. The identifier may be, for example, “%TIMEBASED%.”

In an example, content is requested using a predetermined time unit, instead of a content unit. In this example, the content requester adds an identifier or otherwise manages information indicating that a content request packet requests content based on a predetermined time unit, to a header of the content request packet, or to a name of the content. Additionally, the content requester may generate, using the name of the content, a content request packet that requests segments of the content.

In 320, the method transmits the content request packet. For example, the content requester 210 transmits the content request packet. For example, either real-time streaming content or general content is requested by the content request packet. The “general content” is understood to be content other than the real-time streaming content. Real-time streaming content is content whose transmission uses a steady transmission rate and changes in real-time. For example, video and audio information, such as movies, television programs, music, and audiobooks, are all examples types of content that require real-time streaming to use if they are not previously downloaded. General content does not require a steady transmission rate.

In 330, the method receives at least one segment of content that corresponds t a predetermined time unit. For example, the content requester 210 receives at least one segment of the content that corresponds to the predetermined time unit. The “at least one segment of the content that corresponds to the predetermined time unit” is understood to be at least one segment of content transferred within the predetermined time unit.

The content requester 210 determines whether transmission of the at least one segment received in 330 fails. In an example in which the transmission of the at least one segment is determined to fail, the content requester 210 requests retransmission of the at least one segment. By requesting retransmission, the content requester 210 ensures that all data is transmitted in an efficient manner.

When real-time streaming content is received in 330, the content requester 210 may, for example, process the received real-time streaming content using a scheme different from a scheme of processing general content. In one example in which real-time streaming content is received in 330, the content requester 210 stores a latest segment in a storage space for the real-time streaming content. For example, when a missing segment or an out-of-order segment is included in segments of the real-time streaming content, if a segment is missing or out-of-order for real-time streaming content, it is necessary to correct the error. Additionally, there is limited time to correct the error.

Hence, as an example of how such errors are handled, the content requester 210 requests retransmission of the real-time streaming content, using a latest segment stored in a content store 110. The “requesting retransmission of the real-time streaming content, using the latest segment stored in the content store” indicates statuses of segments. As an example, when transmission of a segment 7 succeeds, when transmission of segments 8 and 9 fails, and when transmission of a segment 10 succeeds, the content requester determines the transmission of the segments 8 and 9 to fail, based on the segment 10 stored in the content store, and requests retransmission of the segments 8 and 9. However, it is not necessary to retransmit 7 and 10 as their transmission was previously successful.

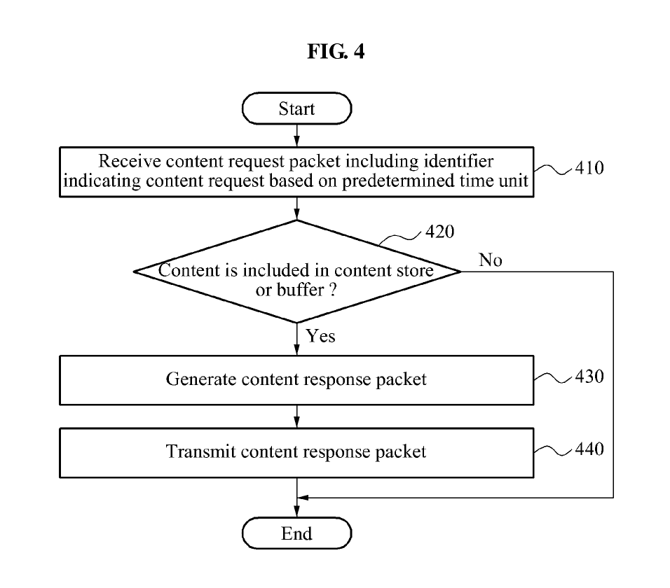

FIG. 4 illustrates an example of a communication method of a content provider to provide content based on a predetermined time unit in a CCN based on a content name.

Referring to FIG. 4, in 410, the method receives a content request packet including an identifier indicating a content request based on a predetermined time unit. For example, the content provider receives a content request packet including an identifier indicating a content request based on a predetermined time unit to request content.

In 420, the method determines if the content is included in the content store or content buffer. For example, the content provider 210 determines whether the content is included in a content store or a buffer. In one approach, the content provider 210 uses a name of the content to determine whether the content is included in the content store or the buffer.

In an example in which the content is determined to be included in the content store or the buffer in 420, the method generates a content response packet in 430. For example, the content provider 210 generates a content response packet in 430. In this example, a content response packet includes at least one segment of the content that corresponds to the predetermined time unit. For example, when content matching a name of content is included in an application, or an alternative environment, in 420, the content provider 210 generates the content. In 430, the method generates a content response packet. For example, the generated content is generated as a content response packet in 430.

In 440, the method transmits the content response packet. For example, the content provider transmits 210 the content response packet.

In an example of how case in which the content is determined not to be included in the content store or the buffer in 420 is handled, the content provider 210 terminates an operation.

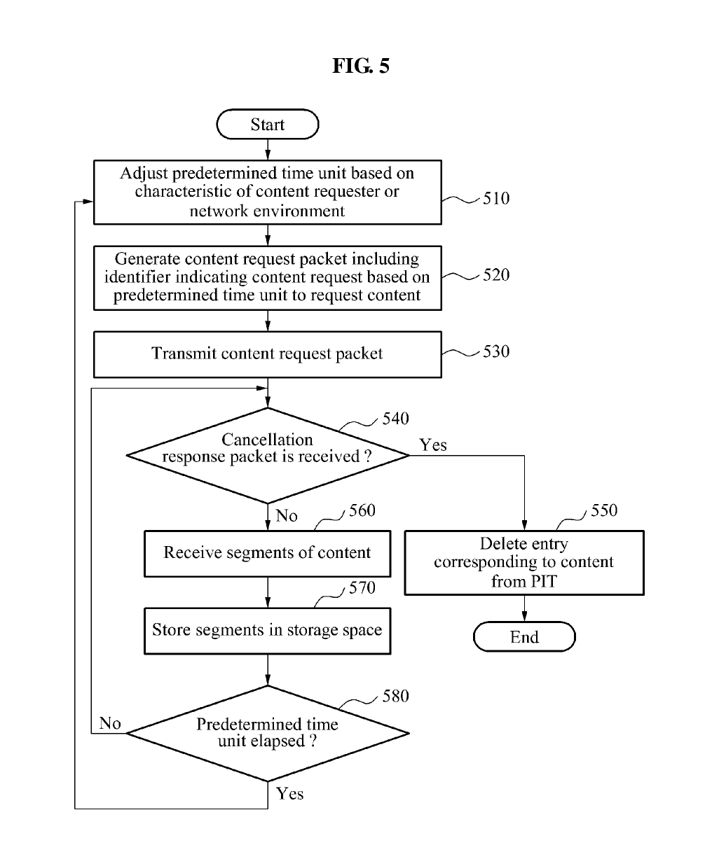

FIG. 5 illustrates another example of a communication method of a content requester to provide content based on a predetermined time unit in a CCN based on a content name.

Referring to FIG. 5, in 510, the method adjusts a predetermined time unit based on a characteristic of the content requester or a network environment. For example, the content requester 210 adjusts the predetermined time unit based on a characteristic of the content requester or a network environment. In an example in which the content requester 210 is assumed to be a terminal with high mobility, the predetermined time unit may be shorter, in comparison to an example in which the content requester is a fixed communication apparatus.

In another example, in which severe interference by the network environment occurs or a large number of losses occur, the predetermined time unit may be shortened, in comparison to an example in which gentle interference by the network environment occurs or a small number of losses occur. Operation 510 is performed first, but there is no limitation on the performance of operation 510, and accordingly in an example the predetermined time unit is adjusted in subsequent operations.

In 520, the method generates a content request packet including an identifier indicating a content request based on a predetermined time unit to request content. For example, the content requester 210 generates a content request packet including an identifier indicating a content request based on a predetermined time unit to request content.

As described above, to fetch a plurality of content segments using a single content request, a predetermined time unit is used, instead of a content unit.

Accordingly, in an example the content requester adds an identifier indicating that the content request packet requests content based on the predetermined time unit to a header of the content request packet or to a name of content. Additionally, in an example, the content requester generates a content request packet requesting segments of the content, by using the name of the content. To do so, the name of the content is modified to include information that helps manage how segments are requested.

For example, when a user A included in a subgroup A in a group A requests content “Broadcast1,” and when an identifier “%TIMEBASED%” indicates that a content request packet requests content based on the predetermined time unit, a content request packet requesting the content “Broadcast1” may have a name of “GroupA/SubGroupA/UserA/%TIMEBASED%/Broadcast1.” In this example, there is only one content packet that corresponds to a predetermined time unit.

In an example, the content requester 210 includes information associated with a predetermined time unit in a header of a content request packet requesting content based on the predetermined time unit. In another example, when a predetermined unit time elapses, the content requester enables the content request packet to expire using the timeout value. For example, the predetermined unit time is a time corresponding to a timeout value included in the header of the content request packet.

In 530, the method transmits the content request packet. For example, content requester 210 transmits the content request packet.

Subsequently, in this example the content requester 210 receive a response to the content request packet.

In 540, the method determines whether a cancellation response packet is received as a response to the content request packet. For example, the content requester determines whether a cancellation response packet is received as a response to the content request packet. The cancellation response packet is used to cancel a request for the content. In an example in which the cancellation response packet is determined to be received in 540, the method deletes an entry corresponding to the content from a PIT in 550, and terminates the method of FIG. 5. For example, the content requester deletes an entry corresponding to the content from a PIT in 550, and terminates the method.

For example, intermediate nodes located along a route, through which the content request packet is transferred, also determine whether the cancellation response packet is received. In an example, in response to the cancellation response packet being determined to be received, the intermediate nodes delete the entry corresponding to the content from the PIT.

In another example, in which the cancellation response packet is determined not to be received in 540, the method receives segments of content in 560. For example, content requester 210 receives segments of the content that correspond to the predetermined time unit in 560. In this example, the “segments of the content that correspond to the predetermined time unit” denotes segments required to play back the content for the predetermined time unit.

For example, when the predetermined time unit is assumed to be 5 seconds (s), the content requester 210 receives segments required to play back content, such as content identified as “Broadcast1” for 5 s. In this example, when five segments, for example the segments 203 of FIG. 2, correspond to 5 s of transmission, the content requester 210 receives five segments. Additionally, when six segments, for example the segments 207 of FIG. 2, correspond to 5 s, the content requester may receive six segments. FIG. 2 also illustrates how the segments are labeled and requested.

In 570, the method stores, in a content store, at least one segment of the content. For example, the content requester 210 stores, in a content store, at least one segment of the content.

In 580, the method determines whether the predetermined time unit has elapsed. For example, the content requester determines whether the predetermined time unit has elapsed.

In an example in which the predetermined time unit has elapsed in 580, the method adjusts the predetermined time unit in 510. For example, the content requester 210 adjusts the predetermined time unit in 510, to generate a new content request packet.

In another example in which the predetermined time unit has not elapsed in 580, the method determines whether the cancellation response packet is received in 540. For example, the content requester 210 determines whether the cancellation response packet is received in 540.

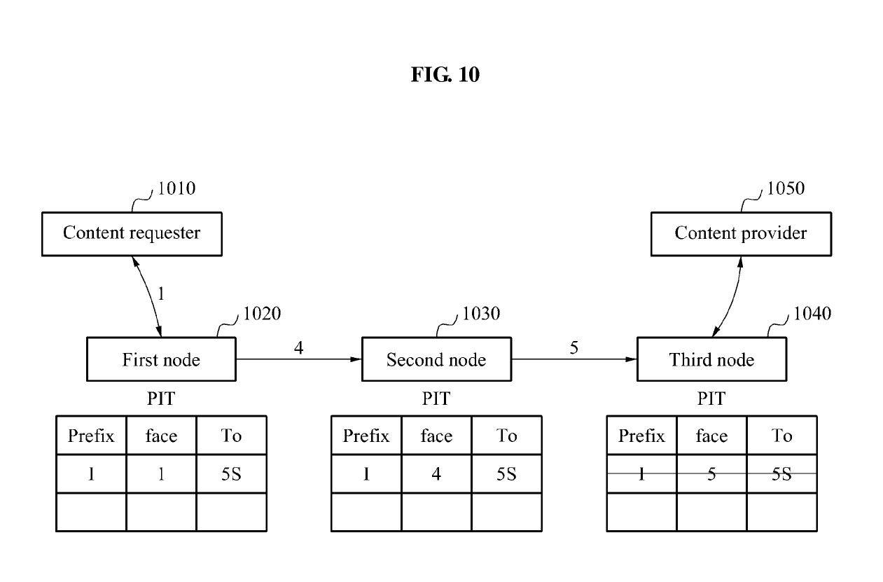

In still another example in which a content request packet requesting content based on a time unit, set in advance, is received from other nodes in the CCN, the content requester 210 stores the time unit in a PIT 130 of the content requester 210. A configuration of a PIT 130, in an example in which a content request packet requesting content based on a predetermined time unit is received, is described with reference to FIG. 10.

The operations described above with reference to FIG. 5 are also potentially performed in intermediate nodes located in a route, through which a content request packet is transferred.

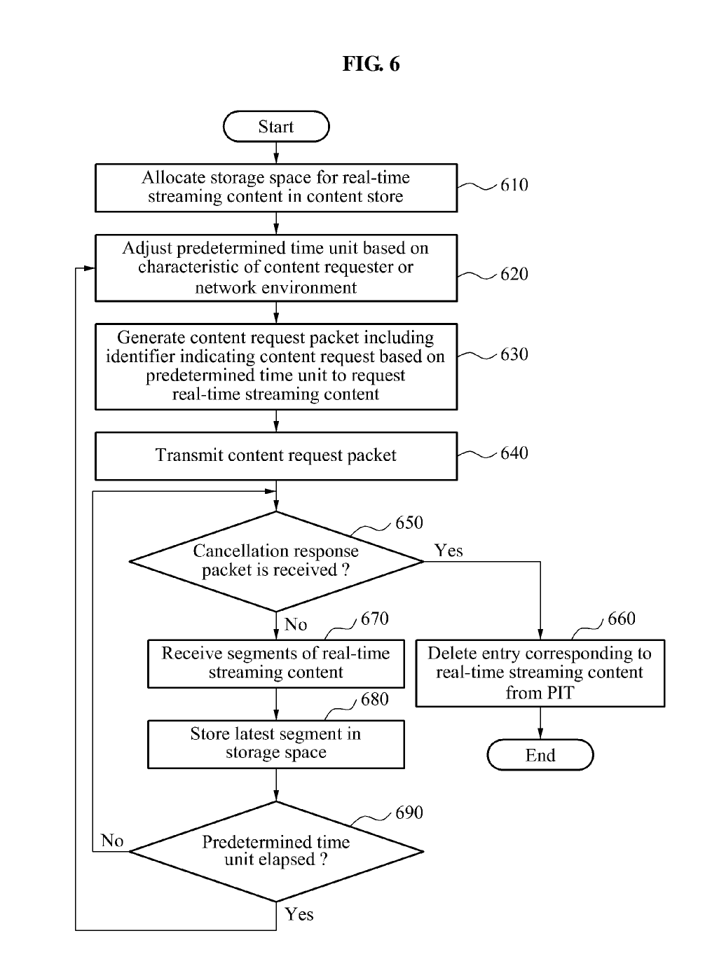

FIG. 6 illustrates an example of a communication method of a content requester to provide real-time streaming content based on a predetermined time unit in a CCN based on a content name.

Referring to FIG. 6, in 610, the method allocates storage space for real-time streaming content in a content store. For example, the content requester 210 allocates a storage space for segment(s) of the real-time streaming content in a content store.

In 620, the method adjusts the predetermined time unit based on a characteristic of the content requester or a network environment. For example, the content requester 210 adjusts the predetermined time unit based on a characteristic of the content requester or a network environment.

In 630, the method generates a content request packet including an identifier indicating a content request based on a predetermined time unit to request real-time streaming content. For example, the content requester 210 generates a content request packet including an identifier indicating a content request based on a predetermined time unit to request real-time streaming content.

As described above, to fetch a plurality of content segments using a single content request, a predetermined time unit may be used, instead of a content unit. In this case, a plurality of content segments corresponding to the predetermined time unit are fetched as part of a single transaction.

Accordingly, in an example, the content requester 210 adds an identifier indicating that the content request packet requests content based on the predetermined time unit to a header of the content request packet or to a name of real-time streaming content. Additionally, in an example, the content requester 210 generates a content request packet requesting segments of the real-time streaming content, by using the name of the real-time streaming content.

For example, if a user A included in a subgroup A in a group A requests real-time streaming content “Broadcast1,” and when an identifier “%TIMEBASED%” indicates that a content request packet requests content based on the predetermined time unit, a content request packet requesting the real-time streaming content “Broadcast1” may have a name of “GroupA/SubGroupA/UserA/%TIMEBASED%/Broadcast1.” Such a name indicates where to obtain the content as well as providing information about the use of the predetermined time unit.

In an example, the content requester 210 includes information associated with a predetermined time unit in a header of a content request packet requesting content based on the predetermined time unit. In another example, when a predetermined unit time elapses, the content requester enables the content request packet to expire using the timeout value. As discussed, the timeout value may be a time corresponding to a timeout value included in the header of the content request packet.

In 640, the method transmits the content request packet. For example, the content requester 210 transmits the content request packet.

Subsequently, in an example the content requester 210 may receive a response to the content request packet.

In 650, the method determines if a cancellation response packet is received. For example, the content requester 210 determines whether a cancellation response packet is received as a response to the content request packet. The cancellation response packet is used to cancel a request for the real-time streaming content. In response to the cancellation packet being received, in 660 the method deletes an entry corresponding to real-time streaming content from the PIT 130. For example, when the cancellation response packet is determined to be received in 650, the content requester 210 deletes an entry corresponding to the real-time streaming content from a PIT 130 in 660, and terminates the method.

For example, intermediate nodes located in a routing path, through which the content request packet is transferred, also determine whether the cancellation response packet is received. In response to the cancellation response packet being determined to be received, the intermediate nodes delete the entry corresponding to the content from the PIT 130. By removing the entry, the nodes indicate that there is no longer an active request for the cancelled content.

In another example, in which the cancellation response packet is determined not to be received in 650, in 670 the method receives segments of real-time streaming content. For example, the content requester 210 receives segments of the real-time streaming content that correspond to the predetermined time unit in 670. In this example, the “segments of the real-time streaming content that correspond to the predetermined time unit” denote segments required to play back the real-time streaming content for the predetermined time unit.

For example, when the predetermined time unit is set to be 5 s, the content requester receives segments required to play back real-time streaming content “Broadcast1” for that 5 s interval. In this example, when five segments, for example the segments 203 of FIG. 2, correspond to 5 s, the content requester 210 receives five segments. Additionally, when six segments, for example the segments 207 of FIG. 2, correspond to 5 s, the content requester 210 receives six segments.

In 680, the method stores the latest segment in the storage space. For example, the content requester 210 stores a latest segment among the received segments in the storage space that was allocated in 610.

In 690, the method determines whether the predetermined time unit elapsed. For example, the content requester 210 determines whether the predetermined time unit elapsed.

In an example in which the predetermined time unit elapsed in 690, the method adjusts the predetermined time unit in 620, to generate a new content request packet. For example, the content requester 210 adjusts the predetermined time unit in 620, to generate a new content request packet.

In another example in which the predetermined time unit did not elapse in 690, the method determines whether the cancellation response packet is received in 650. For example, the content requester 210 determines whether the cancellation response packet is received in 650. Typically, to increase efficiency in a CCN, each node includes a content store 110, and responds to a repetitive request. However, it is sometimes inefficient to store all segments of content in a content store 110. Accordingly, by storing only a predetermined number of segments or a latest segment, it reduces a control overhead in a network through a minimum content request, and to maximize an efficiency of a content store.

In still another example in which a content request packet requesting real-time streaming content based on a time unit, set in advance, is received from other nodes in the CCN, the content requester 210 may store the time unit in a PIT 130 of the content requester 210.

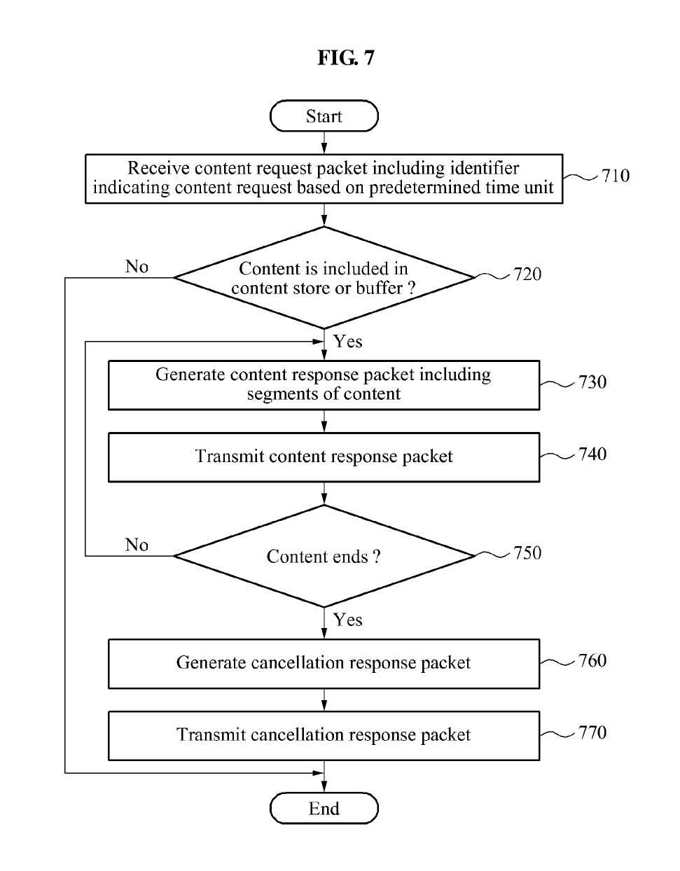

FIG. 7 illustrates another example of a communication method of a content provider to provide content based on a predetermined time unit in a CCN based on a content name.

Referring to FIG. 7, in 710, the method receives a content request packet including an identifier indicating a content request based on a predetermined time unit to request content. For example, the content provider 230 receives a content request packet including an identifier indicating a content request based on a predetermined time unit to request content.

In 720, the method determines whether the content is included in a content store or a buffer. For example, the content provider 230 determines whether the content is included in a content store or a buffer. In 720, in an example, the content provider 230 uses a name of the content to determine whether the content is included in the content store or the buffer. In an example in which the content is determined not to be included in the content store or the buffer in 720, the method terminates. As described above with reference to FIG. 1, in response to determining that corresponding content is not included in a content store, each node in the CCN, for example a content provider 230, determines whether an entry stored with the same content name is included in a PIT 130, and performs a subsequent operation. However, description of the above operation in the CCN is given with reference to FIG. 1, and accordingly further description thereof is omitted for brevity.

In another example in which the content is determined to be included in the content store or the buffer in 720, in 730 the method generates a content response packet including segments of the content. In 740, the method transmits the content response packet. For example, content provider 230 generates a content response packet including segments of the content that correspond to the predetermined time unit in 730, and transmits the generated content response packet in 740.

In 750, the method determines whether the content ends. For example, the content provider determines whether the content ends.

In an example in which the content is determined to end in 750, the method generates a cancellation response packet in 760, and transmits the cancellation response packet to a content requester in 770. For example, the content provider 230 generates a cancellation response packet in 760, and transmits the cancellation response packet to a content requester in 770. The cancellation response packet is used to request the content requester to cancel a request for the content. In this example, the cancellation response packet is transferred to intermediate nodes located in a route from the content provider to the content requester. By doing so, the intermediate nodes are notified that there is no outstanding request for the content.

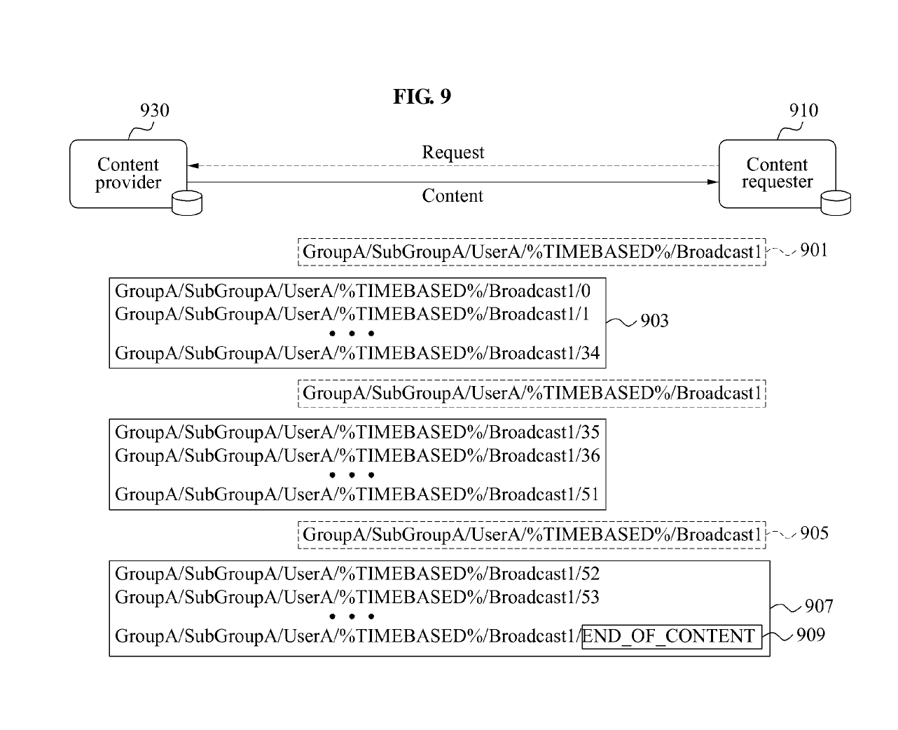

For example, when a cancellation response packet is received, a node, for example an intermediate node or a content requester, ends a received request for content. Example ways of ending a request for content include by either deleting an entry of content from a PIT 130 and the like, or setting a timeout value to “0.” An example in which a content provider 230 ends a content request are described further with reference to FIG. 9.

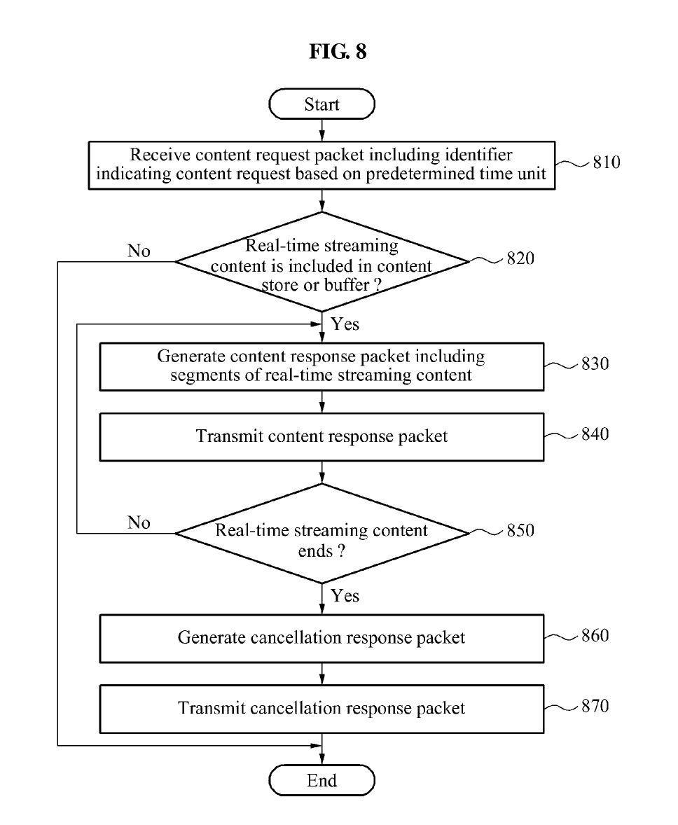

FIG. 8 illustrates an example of a communication method of a content provider to provide real-time streaming content based on a predetermined time unit in a CCN based on a content name.

Referring to FIG. 8, in 810, the method receives a content request packet including an identifier indicating a content request based on a predetermined time unit to request real-time streaming content. For example, the content provider 230 receives a content request packet including an identifier indicating a content request based on a predetermined time unit to request real-time streaming content.

In 820, the method determines whether the real-time streaming content is included in a content store or a buffer. For example, the content provider 230 determines whether the real-time streaming content is included in a content store or a buffer. In 820, in an example, the content provider 230 uses a name of the real-time streaming content to determine whether the real-time streaming content is included in the content store or the buffer. In an example, the buffer is a buffer for streaming. Accordingly, the content provider 230 potentially responds to a request for content that is not included in the content store 110. For example, the content provider 230 provides content stored in a buffer for a streaming service or a similar application.

In an example in which the real-time streaming content is determined not to be included in the content store or the buffer in 820, the method terminates. As described above with reference to FIG. 1, in response to it being determined that corresponding content is not included in a content store 110, each node in a CCN, for example a content provider 230, determines whether an entry stored with the same content name is included in a PIT 130, and performs a subsequent operation. Description of such an operation in the CCN is given with reference to FIG. 1, and accordingly further description thereof is omitted herein.

In another example, in which the real-time streaming content is determined to be included in the content store or the buffer in 820, in 830 the method generates a content response packet including segments of real-time streaming content, and transmits the generated response packet in 840. For example, the content provider 230 generates a content response packet including segments of the real-time streaming content that correspond to the predetermined time unit in 830, and transmits the generated content response packet in 840.

In 850, the method determines whether the content ends. For example, the content provider 230 determines whether the content ends.

In an example in which the real-time streaming content is determined to end in 850, the method generates a cancellation response packet in 860 and transmits a cancellation response packet in 870. For example, the content provider 230 generates a cancellation response packet that cancels a request for the real-time streaming content in 860, and transmits the cancellation response packet to a content requester 210 in 870. In this example, the cancellation response packet is transferred to intermediate nodes located in a route from the content provider 230 to the content requester 210 to aid in transferring the packet.

In another example, in which the real-time streaming content is determined not to end in 850, the method content provider generates a content response packet including segments of the real-time streaming content in 830, as discussed above.

For example, when a cancellation response packet is received, a node, for example an intermediate node or a content requester 210, ends a received request for real-time streaming content. For example, the node ends the received request by either deleting an entry of the real-time streaming content from a PIT 130 and the like, or by setting a timeout value to “0.”

FIG. 9 illustrates an example of a method of ending a request for content in a CCN based on a content name.

Referring to FIG. 9, when the content request ends in the CCN, a content provider 930 notifies content requester 910 of the end of the content, using a scheme described below.

In FIG. 9, a content provider 930 receives a content request packet 901 requesting content based on a predetermined time unit is received from a content requester 910. In response, the content provider 930 transmits at least one content response packet including segments of the content, for example a content response packet 903. In the example of FIG. 9, a content response packet 907 that responds to a content request packet 905 transmitted by the content requester 910 includes a last segment of the content.

For example, when transmission of the content is terminated, the content provider 930 includes preset information 909, for example “END_OF_CONTENT,” in a segment number of the last segment, and transmits the content with the predetermined information 909. The preset information 909 indicates that no further content is to be transmitted.

Additionally, in an example when transmission of the content is terminated, the content provider sets a payload size of the last segment of the content to a preset value, for example “0,” and transmits the content. For example, when a payload size of a last segment of real-time streaming content is set to “0,” real-time streaming content stored in a content store of each node in a route, through which the corresponding real-time streaming content is transmitted, is automatically timed out, and subsequently deleted.

FIG. 10 illustrates an example of a change in a PIT of each of the nodes between a content requester and a content provider using a time-based interest protocol, to provide content in a CCN based on a content name.

In the example of FIG. 10, a first node 1020, a second node 1030, and a third node 1040 are used as intermediate nodes to transfer a content request packet from a content requester 1010 to a content provider 1050, and are assumed not to include content “I” requested by the content requester 1010.

In FIG. 10, the first node 1020 receives a content request packet via face “1” from the content requester 1010, and the second node 1030 receives the content request packet via face “4” from the first node 1020. The third node 1040 receives the content request packet via face “5” from the second node 1030.

Referring to FIG. 10, when a content request packet including an identifier indicating a content request based on a predetermined time unit is received from the content requester 1010, the first node 1020 describes, in an entry of a PIT of the first node 1020, a name of the real-time streaming content “I” requested by the content requester 1010, and the face “1” via which the content request packet is received. In addition, the first node 1020 stores, in the PIT, a name of a content request packet that requests the content “I,” or a predetermined time unit “5S” recognized based on a header of the content request packet.

Similarly, the second node 1030 and the third node 1040 also manage their respective PITs, and transfer the content request packet to the content provider 1050. Subsequently, in an example, the third node 1040 receives a content response packet corresponding to the content “I” from the content provider 1050 and transfers the received content response packet to the second node 1030. In another example, the third node 1040 receives a cancellation response packet used to cancel a request for content based on an end of the content “I,” and deletes an entry of the content from the PIT. FIG. 10 shows the PIT of the third node 1040 with strikethrough to indicate that it receives a cancellation response packet, and deletes the corresponding entry in its PIT.

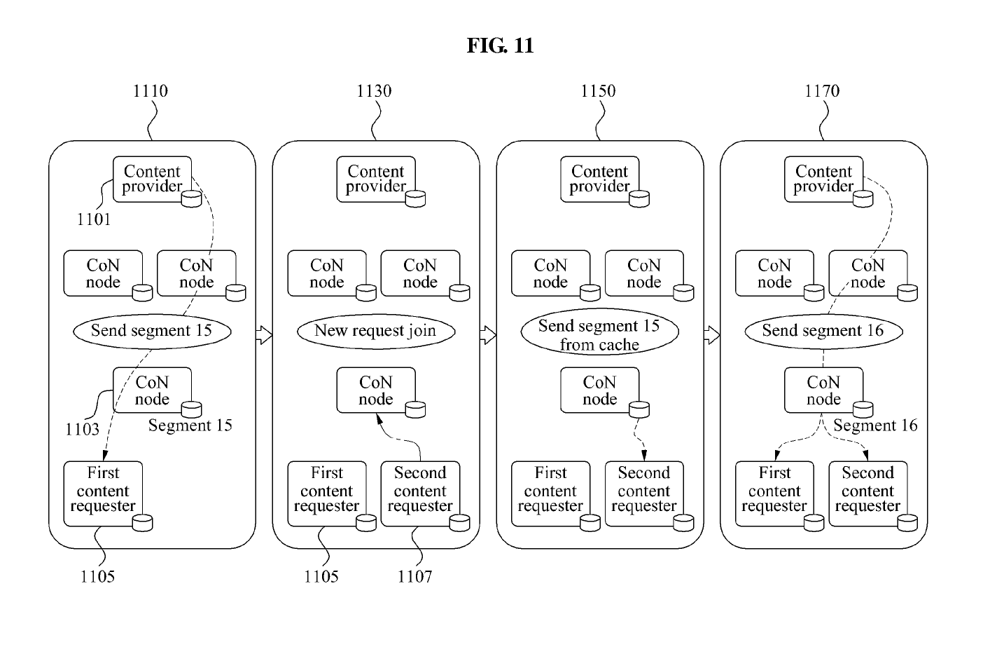

FIG. 11 illustrates an example in which real-time streaming content is provided to a new content requester during providing of real-time streaming content based on the communication methods of FIGS. 6 and 8.

Referring to FIG. 11, nodes in a CCN, for example intermediate CoN nodes, provide real-time streaming content, in response to a request by a new node.

In FIG. 11, while a content provider 1101 provides a first content requester 1105 with segments of real-time streaming content, a new content requester, namely, a second content requester 1107 is also designated to receive the same real-time streaming content.

As illustrated in a box 1110 of FIG. 11, the content provider 1101 transmits segments of real-time streaming content to the first content requester 1105 through the nodes. In this example, a latest segment among the segments of the real-time streaming content, for example a segment 15, is stored in a content store of an intermediate node 1103.

Subsequently, when the second content requester 1107 requests the real-time streaming content, a request by the second content requester 1107 for the real-time streaming content is transferred to the intermediate node 1103, as illustrated in a box 1130 of FIG. 11. The intermediate node 1103 transmits the segment 15 stored in the content store to the second content requester 1107, as illustrated in a box 1150 of FIG. 11.

When a new segment 16 of the real-time streaming content is received from the content provider 1101, the intermediate node 1103 may provide the segment 16 to both the first content requester 1105 and the second content requester 1107, as illustrated in a box 1170 of FIG. 11.

Depending upon the capabilities of the nodes, the content stores of each of the nodes in the CCN store an enormous amount of information. However, there are still limitations to the quantity of information that the nodes store. For example, when each of the nodes stores all segments of real-time streaming content, a content store may be occupied mostly or exclusively by the real-time streaming content. Real-time streaming content is often not frequently requested over time, due to the nature of real-time streaming content. Hence, storing too much real-time streaming content may make it difficult to smoothly operate the CCN.

Therefore, only a latest segment among segments of real-time streaming content, or only a predetermined number of segments may be stored in a content store, and accordingly a storage space is more effectively used. Additionally, in some examples, only the latest segment is stored in the content store, and thus an operation in which a content requester acquires information regarding segments of currently provided real-time streaming content may not be present.

In addition, in a network environment tangled like a cobweb, that is having a haphazard arrangement, a content store includes information regarding a latest segment among segments of real-time streaming content, despite an order of the segments being reversed. Thus, it is possible for examples to ignore previous segments that are already transferred, and to prevent the order of the segments from being reversed.

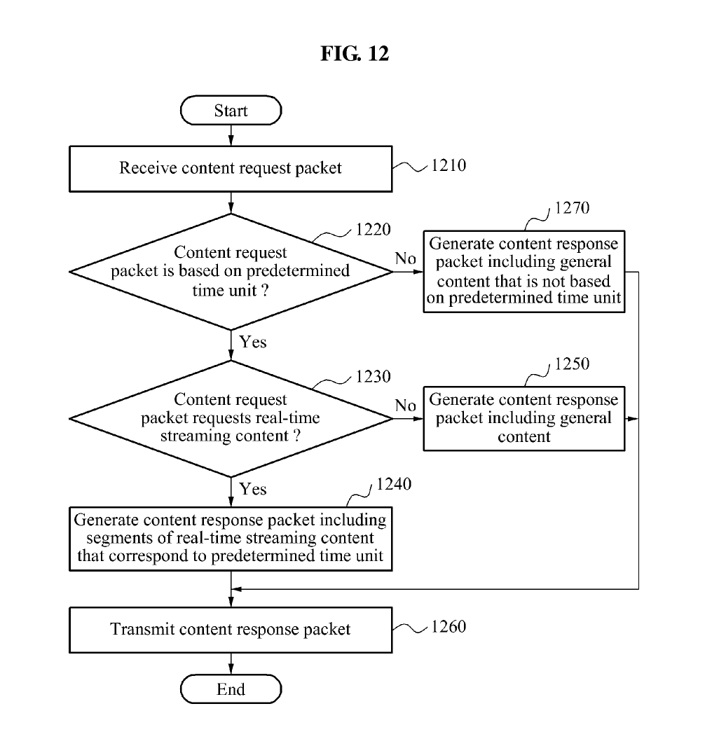

FIG. 12 illustrates an example of a communication method of a content provider when content based on a predetermined time unit, together with general content that is not based on a predetermined time unit, are transmitted in a CCN based on a content name.

Referring to FIG. 12, in 1210 the method receives a content request packet in and in 1220 the method determines whether the received content request pack is based on the predetermined time unit. For example, the content provider receives a content request packet in 1210, and determines whether the received content request packet is based on the predetermined time unit in 1220.

For example, in 1220, the content provider determines whether the content request packet is based on the predetermined time unit, depending on whether an identifier indicating a content request based on the predetermined time unit is included in a header of the content request packet or a name of content.

In 1230, the method determines if the content request packet requests real-time streaming content. For example, based on a determination result obtained in 1220, the content provider determines which one of real-time streaming content based on the predetermined time unit, and general content based on the predetermined time unit is requested by the content request packet.

In an example in which the content request packet is determined to be based on the predetermined time unit in 1220, the content provider may determine whether the content request packet requests real-time streaming content in 1230.

For example, in 1230, the content provider uses information included in the header of the content request packet, to determine which one of the real-time streaming content based on the predetermined time unit, and the general content based on the predetermined time unit is requested by the content request packet. For example, when an indicator indicating real-time streaming content is included in the header of the content request packet, or when segment information included in the header is null, or when a preset value, for example “−1,” is included in the header, the content provider determines that the real-time streaming content is requested in 1230.

In an example in which the content request packet is determined to request the real-time streaming content in 1230, the method generates a content response packet including segments of the real-time streaming content that correspond to the predetermined time unit in 1240. For example, the content provider generates a content response packet including segments of the real-time streaming content that correspond to the predetermined time unit in 1240.

In another example in which the content request packet is determined not to request the real-time streaming content in 1230, the method generates a content response packet including general content in 1250. For example, the content provider generates a content response packet including general content in 1250.

In 1260, the method transmits the content response packet. For example, content provider transmits the content response packet generated in 1240 or 1250.

In another example, in which the content request packet is determined not to be based on the predetermined time unit in 1220, the method generates a content response packet including general content that is not based on the predetermined time unit in 1270, and transmits the generated content response packet to the content requester in 1260. For example, the content provider generates a content response packet including general content that is not based on the predetermined time unit in 1270, and transmits the generated content response packet to the content requester in 1260.

Hereinafter, a method of exchanging a content request packet and a content response packet between a content requester and a content provider, using a time-based interest protocol, is described with reference to FIGS. 13 and 14.

FIG. 13 illustrates an example of a method of restoring a hole generated during transmission of segments between a content requester and a content provider using a time-based interest protocol in a CCN.

A content request packet transmitted in the time-based interest protocol includes, for example, information regarding a time duration or an identifier indicating a predetermined time unit. In the time-based interest protocol, based on the time-related information, a plurality of content segments may be generated from another node, for example a content provider 1330, and may be transferred for the predetermined time unit or time duration to a content requester 1310. There is no set limit on the number of content segments.

Because the content requester 1310 and the content provider 1330 request and transfer segments in a predetermined time unit, instead of a segment unit, a portion of the segments may be missing or out of order.

The content requester 1310 determines whether a missing segment or an out-of-order segment is included in segments of content received from the content provider 1330.

Referring to FIG. 13, a segment 2 seg 2 is out of order during transmission of the content “ccnx://sen/testfile.txt.” In the following description, segment(s) that are missing or out of order during transmission, for example the segment 2 seg 2, are referred to as “holes.”

The content requester 1310 detects holes, using segment numbers described in a name field of a content response packet including segment(s) of content.

The content requester 1310 determines whether a portion of all content segments received from the content provider 1330 is missing or out of order, during transmission.

For example, in FIG. 13, when a missing segment or an out-of-order segment, namely a hole, is detected first, the content requester 1310 waits for a predetermined time interval called “hole timeout” until the missing segment or the out-of-order segment is transmitted. The hole timeout is calculated or specified by a network condition or a service scenario, before a hole recovery request packet is transmitted from the content requester 1310 to the content provider 1330.

In FIG. 13, the hole timeout is calculated using a round trip time (RTT), for example, by the equation “Hole timeout=(RTT*constant value A).” The RTT, in an example, is continuously measured between a corresponding node and an adjacent node, though it may also be measured at specific instances in time. The constant value A may be, for example, “1.5,” “2.5,” and the like. Additionally, in an example, the hole timeout is determined using a number of segment(s) received after the content requester 1310 detects a hole. For example, referring to FIG. 13, when the content requester 1310 detects a hole (for example, the segment 2 seg 2), and then receives two segments, namely a segment 3 seg 3 and a segment 4 seg 4, the content requester 1310 determines a time interval in which the two segments are received, to be a hole timeout.

The content requester 1310 determines whether a missing segment or an out-of-order segment is transmitted for a predetermined time interval, for example, a hole timeout. Based on a result of the determining, the content requester 1310 generates a content request packet requesting a missing segment or an out-of-order segment.

In an example in which a missing segment or an out-of-order segment is determined not to be transmitted for a hole timeout, the content requester 1310 generates a content request packet requesting a missing segment or an out-of-order segment, such as for example, the segment 2. In this example, a general content request packet, for example, “ccnx://sen/testfile.txt/seg2” that does not include an identifier indicating a content request based on a predetermined time unit is generated.

For example, a content request packet requesting a missing segment or an out-of-order segment rather than including an identifier indicating a content request based on a predetermined time unit, instead includes a segment number of a missing segment or an out-of-order segment (for example, the segment 2 seg2) in a name field. In this example, the content request packet may correspond to the above-described “hole recovery request packet.”

The content requester 1310 transmits a content request packet requesting a missing segment or an out-of-order segment to the content provider 1330.

Depending on various examples, the content requester 1310 generates content request packets with different forms, based on a number of segments that are missing or out of order, and transmits the generated content request packets to the content provider 1330.

The content requester 1310 compares the number of the segments that are missing or out of order with a predetermined number of segments, and generates content request packets that have different forms and that request a missing segment or an out-of-order segment, based on a result of comparison.

In an example in which the number of the segments that are missing or out of order is equal to or less than the predetermined number, the content requester 1310 generates a general content request packet including segment numbers of the segments. In another example in which the number of the segments that are missing or out of order is greater than the predetermined number, the content requester 1310 generates a content request packet that requests a missing segment or an out-of-order segment and that also includes an identifier indicating a content request based on a predetermined time unit. The predetermined number is determined based on a network condition or a service scenario, and may be set, for example, to “1” or “2.”

For example, when a segment 5 is determined to be missing or out of order, the content requester 1310 transmits a segment number “5” or seg 5 of the segment 5 using a general content request packet, and re-receives the segment 5 from the content provider 1330.

It is inefficient for the content requester 1310 to generate 10 content request packets that respectively request 10 segments (for example, segments 11 to 20) that are missing or out of order. As an alternative, the content requester 1310 simultaneously requests the segments 11 to 20 using a single content request packet including an identifier indicating a content request based on a predetermined time unit. The content provider 1330 transmits a content response packet including the segments 11 to 20 to the content requester 1310. In other words, a plurality of segments is more efficiently transmitted.

FIG. 14 illustrates an example of a method of processing a content store of a network node using a time-based interest protocol in a CCN.

The content store of the network node may enhance network efficiency in the CCN. When a name of a content segment stored in the content store of the network node in the CCN is matched to a name of an interest, namely a content request packet, all nodes may respond to a content request.

For a content request based on a time unit, a content requester in an example transmits a content request packet with a name field in which a segment number is not described, to request a plurality of content segments using a single content request packet.

FIG. 14 illustrates a process of processing a cache that uses information of a starting segment and a predetermined time unit included in a header of a content request packet, for a content request based on a time unit.

To receive a response from a content store of a neighboring network node, for example, a node A 1430, a content requester 1410 adds, to a header of a content request packet, information regarding a starting segment of content, for example, segments seg 0 and seg 379, and other segments from which transmission is started, and a predetermined time unit, for example, T1, in which content “ccnx://sen/testfile.txt” continues to be transmitted, and transmits the content request packet to an adjacent node, namely, the node A 1430. The information regarding the starting segment includes, for example, a number of a first starting segment from which transmission is started every predetermined time unit, for example, T1.

When a time unit-based content request packet is received, the node A 1430 sequentially responds to all content segments stored in a cache of the node A 1430. The node A 1430 stores a segment 0 seg 0 through a segment 204 seg 204 among segments of real-time streaming content, and a node B 1450 stores all segments of content.

When the content request packet with the header including the information regarding the starting segment, for example, the segment seg 0, and the predetermined time unit, for example, T1, is received, the node A 1430 sequentially provides the content requester 1410 with the segment 0 seg 0 through the segment 204 seg 204 stored in the cache.

In an example, the node A 1430 generates a content request packet requesting content segments other than segments stored in the cache, and transmits the generated content request packet to a next node, namely, the node B 1450. Additionally, the node A 1430 transmits a time-based interest to the next node B 1450. The time-based interest may include a time interval shortened based on a cache processing time, for example, “T1-T2,” or “T1-T3”, and a segment number of a starting segment that is not stored in the cache of the node A 1430. The “starting segment” is understood to be a first segment among requested segments other than the segments stored in the cache.

When a content request packet with a header including a segment number of a starting segment, for example, a segment seg 205 and a time unit “T1-T2” is received from the node A 1430, the node B 1450 sequentially respond to all content segments stored in a cache of the node B 1450. For example, when all content segments are not stored in the node B 1450, the node B 1450 transmits a content request packet based on another time unit to a next node, to request segments other than segments stored in the cache.

When a predetermined time unit T1 expires, the content requester 1410 transmits, to the node A 1430, a content request packet that includes information regarding a segment seg 379 next to a segment seg 378, received last by a content request packet corresponding to the predetermined time unit, and a time unit T1 next to the predetermined time unit.

Additionally, when the predetermined time unit T1 expires, the content requester 1410 in one example recognizes a segment number of the segment seg 379 by the segment seg 378 received last in the predetermined time unit T1.

When the content request packet, including the information regarding the next segment seg 379 and the time unit T1 next to the predetermined time unit, is received from the content requester 1410, the node A 1430 transfers, to the content requester 1410, segments, for example, segments seg 379 through seg 381, that are received already from the node B 1450, but that are not transferred due to expiration of the predetermined time unit T1.

A time unit required to transmit the segments for example, segments seg 379 through seg 381, that are stored in the cache of the node A 1430, but that are not transferred to the content requester 1410 is referred to as “T3.” The node A 1430 thus transmit, to the next node, namely the node B 1450, a content request packet that includes a time interval, for example, “T1-T3”, shortened due to a cache processing time, and a segment number of a starting segment seg 382 that is not stored in the cache of the node A 1430.

When the content request packet including the time interval, for example, “T1-T3”, and the segment number of the starting segment seg 382 is received, the node B 1450 transfers the starting segment seg 382 to the content requester 1410 through the node A 1430.

The examples of a communication method of a content requester and a content provider to provide content and real-time streaming content using a predetermined time unit in a Content-Centric Network (CCN) based on a content name may improve communication of content in a CCN. Additionally, by using a predetermined time unit to manage communication of content in a CCN, the examples are well-suited for use in a context of real-time streaming of content.

The apparatuses and units described herein may be implemented using hardware components. The hardware components may include, for example, controllers, sensors, processors, generators, drivers, and other equivalent electronic components. The hardware components may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The hardware components may run an operating system (OS) and one or more software applications that run on the OS. The hardware components also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, a hardware component may include multiple processors or a processor and a controller. In addition, different processing configurations are possible, such as parallel processors.

The methods described above can be written as a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device that is capable of providing instructions or data to or being interpreted by the processing device. The software also may be distributed over network coupled computer systems so that the software is stored and executed in a distributed fashion. In particular, the software and data may be stored by one or more non-transitory computer readable recording mediums. The media may also include, alone or in combination with the software program instructions, data files, data structures, and the like. The non-transitory computer readable recording medium may include any data storage device that can store data that can be thereafter read by a computer system or processing device. Examples of the non-transitory computer readable recording medium include read-only memory (ROM), random-access memory (RAM), Compact Disc Read-only Memory (CD-ROMs), magnetic tapes, USBs, floppy disks, hard disks, optical recording media (e.g., CD-ROMs, or DVDs), and PC interfaces (e.g., PCI, PCI-express, WiFi, etc.). In addition, functional programs, codes, and code segments for accomplishing the example disclosed herein can be construed by programmers skilled in the art based on the flow diagrams and block diagrams of the figures and their corresponding descriptions as provided herein.

As a non-exhaustive illustration only, a terminal/device/unit described herein may refer to mobile devices such as, for example, a cellular phone, a smart phone, a wearable smart device (such as, for example, a ring, a watch, a pair of glasses, a bracelet, an ankle bracket, a belt, a necklace, an earring, a headband, a helmet, a device embedded in the cloths or the like), a personal computer (PC), a tablet personal computer (tablet), a phablet, a personal digital assistant (PDA), a digital camera, a portable game console, an MP3 player, a portable/personal multimedia player (PMP), a handheld e-book, an ultra mobile personal computer (UMPC), a portable lab-top PC, a global positioning system (GPS) navigation, and devices such as a high definition television (HDTV), an optical disc player, a DVD player, a Blu-ray player, a setup box, or any other device capable of wireless communication or network communication consistent with that disclosed herein. In a non-exhaustive example, the wearable device may be self-mountable on the body of the user, such as, for example, the glasses or the bracelet. In another non-exhaustive example, the wearable device may be mounted on the body of the user through an attaching device, such as, for example, attaching a smart phone or a tablet to the arm of a user using an armband, or hanging the wearable device around the neck of a user using a lanyard.

A computing system or a computer may include a microprocessor that is electrically connected to a bus, a user interface, and a memory controller, and may further include a flash memory device. The flash memory device may store N-bit data via the memory controller. The N-bit data may be data that has been processed and/or is to be processed by the microprocessor, and N may be an integer equal to or greater than 1. If the computing system or computer is a mobile device, a battery may be provided to supply power to operate the computing system or computer. It will be apparent to one of ordinary skill in the art that the computing system or computer may further include an application chipset, a camera image processor, a mobile Dynamic Random Access Memory (DRAM), and any other device known to one of ordinary skill in the art to be included in a computing system or computer. The memory controller and the flash memory device may constitute a solid-state drive or disk (SSD) that uses a non-volatile memory to store data.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A communication method of a content requester to provide content in a Content-Centric Network (CCN) based on a content name, comprising:
generating a content request packet, comprising an identifier indicating a content request based on a predetermined time unit, to request the content;
transmitting the content request packet; and
receiving segments of the content that correspond to the predetermined time unit.

2. The communication method of claim 1, wherein the content comprises either real-time streaming content or general content.

3. The communication method of claim 1, wherein the generating comprises generating a content request packet requesting the segments of the content using a name of the content.

4. The communication method of claim 1, wherein the generating comprises adding the identifier to a header of the content request packet or to a name of the content.

5. The communication method of claim 1, wherein the generating comprises adding, to a header of the content request packet, information regarding a starting segment of the content and the predetermined time unit to which the content corresponds.

6. The communication method of claim 5, further comprising:
transmitting a content request packet comprising information regarding a segment sequentially following a segment received last by a content request packet corresponding to the predetermined time unit and a time unit sequentially following the predetermined time unit, in response to the predetermined time unit expiring.

7. The communication method of claim 1, further comprising:
adjusting the predetermined time unit, based on a characteristic of at least one of the content requester and a network environment.

8. The communication method of claim 1, further comprising:
storing the predetermined time unit corresponding to the content request packet in a Pending Interest Table (PIT).

9. The communication method of claim 1, further comprising:
deleting an entry corresponding to the content from a Pending Interest Table (PIT), in response to a cancellation response packet that comprises a request for the content to be cancelled.

10. The communication method of claim 9, wherein the deleting comprises deleting the entry corresponding to the content from the PIT, using a timeout value included in the header of the content request packet.

11. The communication method of claim 1, further comprising:
determining whether a missing segment or an out-of-order segment is included in the received segments; and
waiting for a predetermined time interval, in response to the missing segment or the out-of-order segment being detected.

12. The communication method of claim 11, further comprising:
determining whether the missing segment or the out-of-order segment is transmitted to the content requester during the predetermined time interval;
generating a content request packet requesting the missing segment or the out-of-order segment, in response to determining that the missing segment or the out-of-order segment is not transmitted during the predetermined time interval; and
transmitting the content request packet requesting the missing segment or the out-of-order segment, in response to the content request packet being generated.

13. The communication method of claim 12, wherein the content request packet requesting the missing segment or the out-of-order segment has a name field comprising a segment number of the missing segment or the out-of-order segment, instead of comprising an identifier indicating a content request based on the predetermined time unit.

14. The communication method of claim 12, wherein the generating of the content request packet requesting the missing segment or the out-of-order segment comprises:
comparing a number of segments that are missing or out of order with a predetermined number; and
generating content request packets that have different forms and that request the missing segment or the out-of-order segment, based on a result of the comparing between the number of segments that are missing or out of order and the predetermined number.

15. The communication method of claim 14, wherein the generating of the content request packets comprises, in response to the number of the segments that are missing or out of order being equal to or less than the predetermined number, generating a content request packet comprising a segment number of the missing segment or the out-of-order segment.

16. The communication method of claim 14, wherein the generating of the content request packets comprises, in response to the number of the segments that are missing or out of order being greater than the predetermined number, generating a content request packet that requests the missing segment or the out-of-order segment and that comprises an identifier indicating a content request based on the predetermined time unit.

17. The communication method of claim 1, further comprising:
allocating a storage space for real-time streaming content in a content store, in response to the content being the real-time streaming content.

18. The communication method of claim 17, further comprising:
storing a latest segment among received segments of the real-time streaming content in the storage space.

19. The communication method of claim 18, further comprising:
requesting retransmission of the real-time streaming content using the latest segment, in response to a missing segment or an out-of-order segment being included in the segments of the real-time streaming content.

20. A communication method of a content provider to provide content in a Content-Centric Network (CCN) based on a content name, comprising:
receiving a content request packet comprising an identifier indicating a content request based on a predetermined time unit;
determining whether the content is included in a content store or a buffer of the content provider;
generating a content response packet comprising segments of the content, in response to determining that the content is included in the content store or the buffer of the content provider, the segments corresponding to the predetermined time unit; and
transmitting the content response packet.

21. The communication method of claim 20, wherein the content comprises either real-time streaming content, or general content.

22. The communication method of claim 20, wherein the determining comprises determining whether the content is included in the content store or the buffer, using a name of the content.

23. The communication method of claim 20, further comprising:
generating a cancellation response packet that causes a request for the content to be cancelled, in response to the content ending.

24. The communication method of claim 23, wherein the generating of the cancellation response packet comprises generating the cancellation response packet, by describing preset information for a segment number of a last segment of the content, or by setting a payload size of the last segment to a preset value.

25. The communication method of claim 23, further comprising:
transmitting the cancellation response packet.

26. The communication method of claim 20, wherein the receiving comprises receiving a content request packet comprising information regarding a starting segment of the content and the predetermined time unit in which the content continues to be transmitted.

27. The communication method of claim 20, wherein the receiving comprises, in response to the predetermined time unit expiring, receiving a content request packet comprising information regarding a segment sequentially following a segment received last by a content request packet corresponding to the predetermined time unit and a time unit sequentially following the predetermined time unit.

28. The communication method of claim 20, wherein the receiving comprises receiving a content request packet comprising a segment number of a first segment among segments of the content that are not stored in a content store of an intermediate node, and a time unit obtained by subtracting a time interval required to process a segment stored in the content store of the intermediate node from the predetermined time unit.

29. The communication method of claim 20, further comprising:
receiving a content request packet requesting a missing segment or an out-of-order segment among segments of the content.

30. The communication method of claim 29, wherein the content request packet requesting the missing segment or the out-of-order segment has a name field comprising a segment number of the missing segment or the out-of-order segment, instead of comprising an identifier indicating a content request based on the predetermined time unit.

31. A communication method of a content provider to provide content in a Content-Centric Network (CCN) based on a content name, comprising:
receiving a content request packet;
determining whether the content request packet is based on a predetermined time unit;
deciding whether the content is real-time streaming content based on the predetermined time unit or general content based on the predetermined time unit is requested by the content request packet, based on a result of the determining;
generating a content response packet in response to the deciding; and
transmitting the content response packet.

32. The communication method of claim 31, wherein the determining comprises determining whether the content request packet is based on the predetermined time unit, based on determining whether an identifier indicating a content request based on the predetermined time unit is included in a header of the content request packet or a name of the content.

33. The communication method of claim 31, wherein the deciding comprises deciding, using information included in the header of the content request packet, whether the content is real-time streaming content based on the predetermined time unit or general content based on the predetermined time unit that is requested by the content request packet

34. The communication method of claim 31, wherein the generating comprises generating a content response packet comprising segments of the real-time streaming content, in response to the real-time streaming content based on the predetermined time unit being decided to be requested.

35. The communication method of claim 31, wherein the generating comprises generating a content response packet comprising the general content based on the predetermined time unit, in response to the general content based on the predetermined time unit being decided to be requested.

36. The communication method of claim 31, further comprising:
generating a cancellation response packet that causes a request for the content to be cancelled, in response to the content ending.

37. The communication method of claim 36, wherein the generating of the cancellation response packet comprises generating the cancellation response packet, by describing preset information in a segment number of a last segment of the content, or by setting a payload size of a last segment to a preset value.

38. The communication method of claim 31, wherein the receiving comprises receiving a content request packet comprising information regarding a predetermined time unit to which the content corresponds.

39. The communication method of claim 38, further comprising:
receiving a content request packet requesting a missing segment or an out-of-order segment among segments of the content,
wherein the content request packet requesting the missing segment or the out-of-order segment has a name field comprising a segment number of the missing segment or the out-of-order segment, instead of comprising an identifier indicating a content request based on the predetermined time unit.

40. The communication method of claim 31, further comprising:
generating a content response packet comprising general content that is not based on the predetermined time unit, in response to the content request packet being determined not to be based on the predetermined time unit.

41. A non-transitory computer readable storage medium storing a program, the program comprising instructions for causing a computer to implement the communication method of claim 1.

42. A communication method of a node in a Content-Centric Network (CCN), comprising:
receiving a content request packet from a content requester, comprising an identifier indicating a request based on a predetermined time unit, to request the content, by a face;
determining whether the requested content is present in a content store of the node;
in response to the requested content being present in a content store of the node, transmitting the requested content from the content store to the content requester;
in response to the requested content not being present in a content store of the node, recording a routing entry for the requested content in a Pending Interest Table (PIT) of the node, and forwarding the content request packet to another node of the CCN using a selected face to retrieve the content.

43. The communication method of claim 42, wherein each routing entry in the PIT comprises a prefix, a face value, and a segment identifier.

44. The communication method of claim 42, wherein the requested content comprises either real-time streaming content or general content.

45. The communication method of claim 42, wherein the forwarding comprises using a Forwarding Information Base (FIB) to determine the selected face.

46. The communication method of claim 42, further comprising:
receiving the retrieved content in response to the forwarded content request packet; and
routing the content to the content requester in response to receiving the retrieved content.
